(19) United States
(12) Patent Application Publication
(10) Pub. No.: US 2006/0112103 A1
(43) Pub. Date: May 25, 2006

(54) SYSTEM AND METHOD FOR REPORTING AND MONITORING DRIVING INCIDENTS

(76) Inventors: Richard Besserman, Phoenix, AZ (US); Mark Hafkey, Mesa, AZ (US)

Correspondence Address: SNELL & WILMER;ONE ARIZONA CENTER, 400 EAST VAN BUREN, PHOENIX, AZ, 850040001, US

(21) Appl. No.: 10/904,637

(22) Filed: Nov. 19, 2004

(51) Int. Cl. G06F 17/30

(52) U.S. Cl. 707/10

(57) ABSTRACT

A system and method for reporting and monitoring driving incidents which includes monitoring for abusive reporting and which enables a driver having an incident report to dispute the report. The system and method can be used to automatically generate driving incident reports to interested subscribers such as parents, employers, and insurance companies.

### FIELD OF INVENTION

The present invention relates generally to a system and method for reporting and monitoring driving incidents. More particularly, the present invention relates to a system and method for reporting and monitoring driving incidents which includes automatic forwarding of driving incident reports to subscribers and the opportunity for those receiving or obtaining bad driving incident reports relating to their driving to dispute such bad incident reports. The present invention also relates to a system and method that is capable or providing customized reports to subscribers.

### BACKGROUND OF INVENTION

The National Highway Transportation Safety Administration (NHTSA) reports that the cost of automobile crashes in the United States topped 230 billion dollars in the year 2000, averaging nearly 820 dollars for every resident in the U.S. This figure includes legal and court costs, emergency service costs, insurance administration costs and travel delays. This represents 2.3 percent of the nation's gross domestic product and explains why insurance rates are so high.

Approximately 42,000 people were killed in the year 2000 and 5.3 million injured in motor vehicle crashes that also damaged 28 million vehicles across the U.S. Vehicle accidents accounted for 32.6 billion dollars in medical costs, $59 billion dollars in property damage losses, 81 billion dollars in lost productivity and $58 billion dollars in other related costs.

Increasing congestion and traffic have heightened the risk of traffic accidents due to impatience, time pressures, and overt “road rage”. Abuse of mind-altering substances such as alcohol and drugs has led to a dramatic increase in highway death and injury. Moreover, there are not nearly enough police officers to have a significant impact on deterring bad driving behavior.

Teenagers and young adults have the highest accident rates and tend to commit the majority of traffic violations when compared to other drivers. Parents are concerned about their teen and young adult drivers and want to keep track of their driving behavior. In addition to parents, employers and insurance companies also have an interest in being able to monitor driving behaviors of their employees and insureds.

Systems and methods for public initiated incident reporting and the monitoring of aggressive drivers are well known in the prior art. For example, U.S. Patent Publication No. US 2002/0116247 discloses a computerized system that enables the public-at-large to electronically create an incident report via the Internet, an intranet, or an extranet, guides the public through the process of creating an incident report, profiles the elements of the incident through iterative sets of logically related questions and answers, and automatically notifies one or more law enforcement agencies of the incident report submitted by the public. In another example, U.S. Pat. No. 6,392,564 describes a system for monitoring and reporting aggressive drivers which includes a camera mounted on a vehicle which can take images near the rear and front of the vehicle when it is in motion, means for activating the camera to take images when an aggressive driver comes within a predetermined distance of the vehicle and/or at a minimum predetermined speed, and means to automatically transmit the images to interested groups such as local law enforcement agencies, government agencies, and insurance companies.

Prior art websites such as ratemydriving.com and 1-800-hows-my-driving.com also exist for filing driving reports and can be accessed by parents and employers that are signed up for family and commercial programs, respectively. Although prior art systems and methods exist for reporting and monitoring both good and bad driving incidents, the prior art does not address the issue of false reporting and how to account for that issue in providing reporting information to others.

Accordingly, there is a need for a system and method for reporting and monitoring driving incidents which provides means for those being reported for bad driving to dispute such a bad driving report so that others having access to the reports will have complete and unbiased information so that they can draw their own conclusions with respect to reports that are made. There is also a need for a system and method for reporting and monitoring driving incidents which addresses the security and integrity of the system so that one reporting person is not able to fabricate multiple reports.

### SUMMARY OF INVENTION

The present invention provides a system and method for reporting and monitoring driving incidents that can be reported by anyone observing a particular driving behavior or driving incident. The system and method provide means for monitoring abuse in reporting driving incidents and also allows the driver, owner, or responsible party relating to a reported incident to dispute the reported incident.

In accordance with one exemplary embodiment of the invention, a method for reporting and monitoring driving incidents includes the steps of registering as a subscriber or member to obtain a free or paid subscription on an internet based website, reporting a driving incident using the license plate number of the vehicle involved in the incident, storing the driving incident report in an electronic database, determining whether the driving incident is related to a paid subscriber, sending an automated notice to the free or paid subscriber that a report has been made, and providing access to a more detailed report of the driving incident to a paid subscriber associated with the driving incident. A more detailed report of a driving incident may also be provided to a free subscriber upon payment of a predetermined fee.

In accordance with another aspect of the invention, a paid subscriber may dispute a driving incident report associated with his or her registered vehicle. The paid subscriber is given an opportunity to review the details of the driving incident report and may detail a responsive dispute with the report and store the details of his or her dispute so that the details of the subscriber's dispute will be reported along with the dispute whenever the report is accessed.

In accordance with another aspect of the invention, the step of reporting a driving behavior or driving incident may be carried out by telephoning an automated telephonic system which prompts the reporter for information, or by entering the information relating to the behavior or incident using the internet via a web page and website directed to collecting such information.

In accordance with still another aspect of the invention, a free subscriber may obtain individual driving incident reports by paying a predetermined fee for each report. Upon paying the fee for such a report, a free subscriber may also dispute the report after viewing the details regarding the incident report.

Driving incident reports are stored by license plate number but each report may be accessed by a number of other identifying criteria that is entered when making a report. These identifying criteria include, but are not limited to, license plate year, date of observation, time of observation, location of observation, vehicle description, driver description, narrative description, and driving observation.

In accordance with yet another aspect of the invention, abusive reporting of driving incidents is monitored by determining whether a single user has reported a driving incident more than once against the same vehicle and blocking the single user from further reporting of incidents relating to that vehicle.

Another exemplary embodiment of the invention includes a system for reporting and obtaining information on driving incidents which includes an internet based registry housed in a website, means for subscribing to the internet based registry as a paid subscriber or free subscriber, means for reporting driving incidents using the internet based registry, a server for accessing the internet based registry, a database for storing driving incident reports entered into the internet based registry, means for automatically forwarding reports of incident reports relating to paid subscribers to the paid subscribers that includes details of the incident, the law, and helpful hints to avoid making a violation in the future, and means for free subscribers to obtain information contained in the driving incident report upon paying a predetermined fee. Access to insurers and/or law enforcement, as well as ad hoc reporting and statistics may also be included in this embodiment.

### BRIEF DESCRIPTION OF THE DRAWINGS

The present invention is illustrated by way of example and not limitation in the accompanying figures, in which like references indicate similar elements, and in which:

FIG. 1 is a schematic showing the system of the present invention for reporting and obtaining information on driving incidents;

FIG. 2 is a flowchart showing the overall general method of the present invention for reporting and monitoring driving incidents;

FIG. 3 is a flowchart showing the detailed method of reporting a driving incident in accordance with the present invention;

FIG. 4 is a flowchart showing the detailed method for a free subscriber to obtain information on driving incident reports in accordance with the present invention; and

FIG. 5 is a flowchart showing the method for monitoring abuse in reporting incident reports in accordance with the present invention.

### DETAILED DESCRIPTION

The present invention is directed to a system and method for reporting and monitoring driving incidents that can be used by anyone who wants to make a driving incident report or who wants to obtain information on driving incident reports that have been made by others. The system accepts and stores both good and bad driving incident reports with reports being made by individuals who have subscribed to the system as either paid subscribers or free subscribers. Subscription to the system as a paid or free subscriber requires the subscriber to enter certain information including e-mail, log in name, password, hint question for password, answer to hint question, residence city, residence state, and residence zip code. At their option, subscribers may also enter their first and last names, business name, street address, and phone number. Paid subscribers also enter their license plate, the state that issued their license plate, and their credit card number for payment. Subscription to the system enables monitoring of abusive reporting and streamlines access to driving incident reports.

The system includes an internet based registry that is housed in a website that is accessible on-line or by an automated telephone attendant. Both paid and free subscribers can report driving observations and submit driving incident reports by accessing the website on-line or telephoning the automated telephone attendant which gathers the information via telephone and enters it on-line through the website. Subscribers reporting driving observations or incidents have the option of remaining anonymous or can elect or can elect to be contacted by interested subscribers such as, for example, parents, employers, or insurance companies who may want to inquire about a particular driving observation or incident of a vehicle registered with the system. Driving observations and incident reports are stored by license plate number and can be queried by any of the database fields or group of fields that are used to enter reporting information.

Paid subscribers can access driving observations and driving incidents in the form of a report or can register to be contacted automatically by e-mail regarding driving observations (or hits) made on a license plate that has been registered to their account. Paid subscribers accessing driving observations and incident reports may also dispute such observations and reports by detailing their dispute and entering it into the system. The following terms and definitions are used in further describing the system and method of the present invention for reporting and monitoring driving incidents.

Member: A paid subscriber, free subscriber, individual subscriber, or business subscriber.

Public Input: Any person reporting driving observations including motorists and pedestrians.

Internet: Persons may access the system on-line via the Internet and World Wide Web to report driving observations and request information.

Automated Telephone Attendant: A system which receives driving observations and incident reports via telephone and enters them into a driving observation database internet registry.

DIOIR: An acronym for Driving Observation Database Internet Registry.

Observation Reports: Reports that describe the specific traffic observations made by individual Client/Complainants regarding a motorist's driving behavior or summary or detailed aggregate reports that are accessible by subscribers.

Client/Complainant: Person observing and making the report regarding a motorist's driving behavior; used interchangeably with user.

Motorist: A person who drives or travels in a vehicle (driver/passenger).

Pedestrian: Person traveling on foot or in a wheelchair.

Paid Subscriber: Those subscribers, whether individual, business, insurance company, law enforcement, or other, who have paid a subscription fee and are registered to receive driving observation reports for those vehicles linked to their account.

Free Subscriber: Those subscribers who have not paid a subscription fee but who have signed up to be able to report unsafe driving and driving incidents, and who can obtain details of unsafe driving reports relating to their license plate number(s) upon payment of a predetermined access fee.

Individual Subscriber: Individuals registered to receive driving observation reports for those vehicles linked to their account.

Business Subscribers: Authorized employees registered to receive driving observation reports for those vehicles registered to their account (e.g., companies with fleet vehicles, government agencies, etc.)

Insurance Company Subscribers: Authorized employees registered to receive driving observation reports.

Parental Subscribers: Parents registered to receive driving observation reports for those vehicles linked to their account.

Other Subscribers: Others registered to receive driving observation reports.

Observation Report: Reported observation of a specific moving violation or good driving behavior, used interchangeably with driving incident report.

Input Fields: Specific data that may be entered into DIOIR when making an observation report, including license plate number, license plate state, date, time, location, vehicle description, driver description, narrative, and complainant identification number.

Moving Violation Type: Specific traffic violation observed by Client/Complainant and reported to DIOIR.

List of Violations: Traffic infractions, including speeding, weaving, tailgating, unnecessary braking, failure to signal, unsafe lane change, impeding traffic, failure to stop for a red signal, failure to stop for a stop sign, failure to yield, improper turn, littering, unsecured load, HOV violation, other, etc.

Database Relationship Fields: Relational Database Relationships

Internet and/or E-mail Access: Method of reporting to subscribers regarding their observation reports.

Individual Inquiry: An individual subscriber's request for specific observation reports.

Business/Employee Query: A business subscriber's request for specific observation reports.

Insurance Company Query: An insurance subscriber's request for specific observation reports.

Parental Query: A parent subscriber's request for specific observation reports.

Others Query: Miscellaneous subscriber's request for specific observation reports.

Internet Reports: Reports accessed by subscribers via the Internet by specific data fields.

E-mail Alert Notification: E-mail alerts sent to a member indicating a report of bad driving on a specific license plate registered to the member's account.

Types of Internet Reports: Allows authorized subscriber to create reports on data available for inquiry by subscribers.

Types of E-Mail Alert Notifications: Lists the type of e-mail notification sent to subscribers.

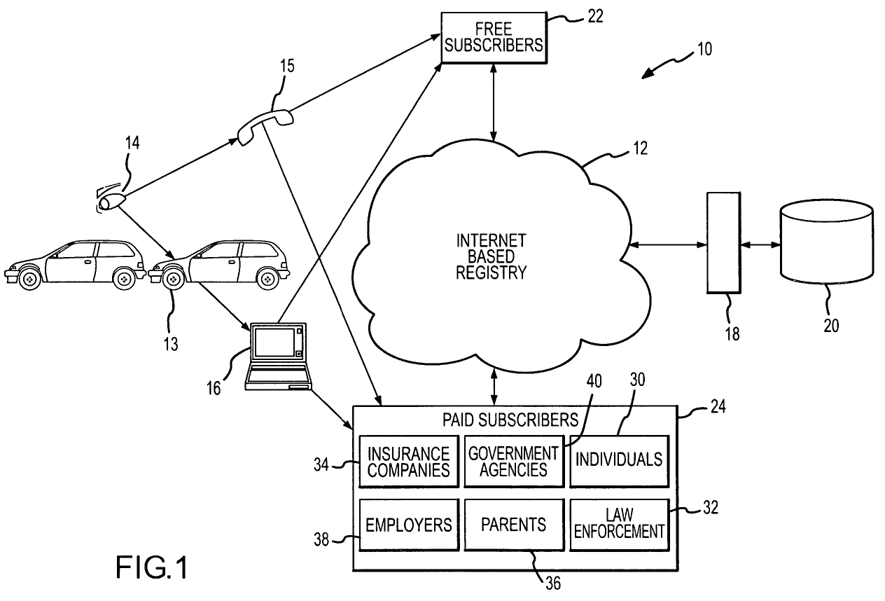

FIG. 1 is a schematic showing the system of the present invention for reporting and obtaining information on driving incidents. In general, the system 10 includes a Driving Observation Database Internet Registry (DIOIR) 12 in which information regarding a driving incident 13 viewed by a Client/Complainant (or User) 14 can be entered into the DIOIR 12 by using a telephone 15 dialed into an automated telephone attendant or a computer 16 (or other device capable of accessing the internet), a server 18 for accessing the information entered into the DIOIR 12, and a database 20 for storing the information accessed by server 18 from the DIOIR 12. Client/Complainant 14 must become either a free subscriber 22 or a paid subscriber 24 in order to enter their driving observation or driving incident into the DIOIR 12.

Free subscribers 22 and paid subscribers 24 can access the DIOIR 12 to obtain information on driving observations and incident reports on those vehicles registered or linked to their accounts. Once driving observations and incident reports are obtained, a paid subscriber having the driving observation or incident report on their record has the opportunity to dispute the report by entering information detailing their dispute into the DIOIR 12.

Paid subscribers 24 may elect to sign up for automatic reporting of incident reports on vehicles registered to, or associated with, their account. Paid subscribers 24 may include, but are not limited to, individuals 30, law enforcement agencies 32, insurance companies 34, parents 36, employers 38, and government agencies 40.

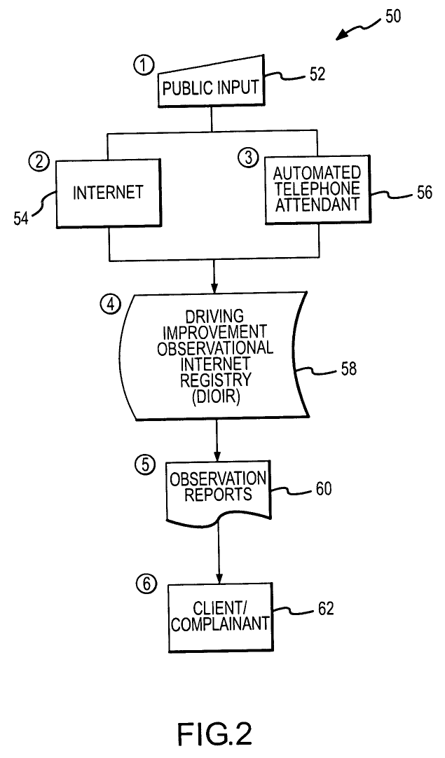

A flowchart depicting the overall general method 50 of the present invention for reporting and monitoring driving incidents is shown in FIG. 2. Public Input 52 is obtained from persons viewing driving behaviors or driving incidents by entering information regarding the driving behaviors or driving incidents into a driving improvement observational internet registry (DIOIR) 58 via a web site and web page on the internet 54 or via a landline or wireless telephone using an automated telephone attendant 56. Detailed information relating to the driving behaviors or driving incidents is stored in a database 60 as observation reports. The observation reports can then be accessed by a Client/Complainant 62 to whom the report was directed. Reports may be sent automatically to Client/Complainants who are paid subscribers or may be accessed individually by Client/Complainants who are paid subscribers. Reports may be accessed individually by free subscribers upon payment of a predetermined fee.

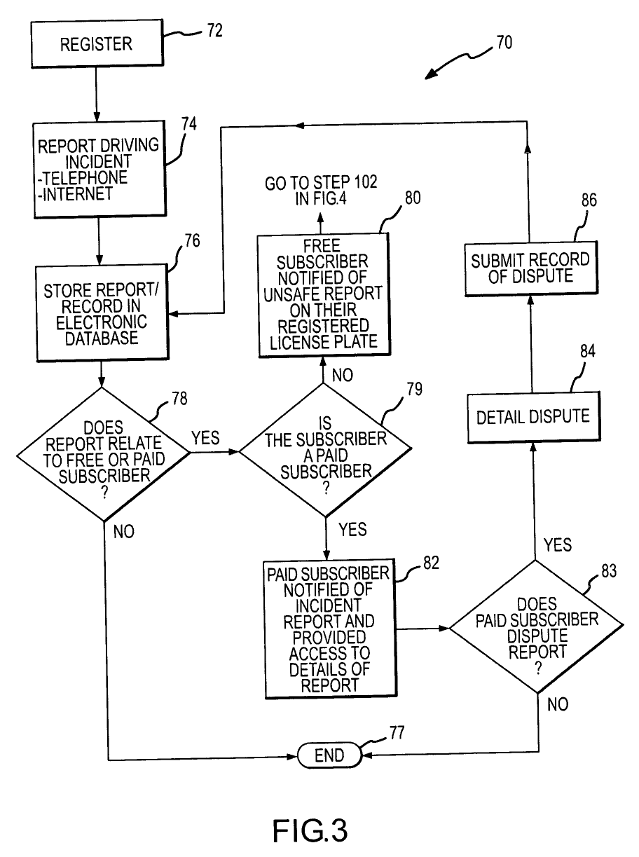

FIG. 3 is a flowchart showing the detailed method of reporting a driving incident 70 in accordance with the present invention. Upon viewing a driving behavior or driving incident that an individual wants to report, the individual or user must first register themselves with the service in step 72 by entering specific personal information such as e-mail address, log in name, password, hint question for password, answer to hint question, residence city, residence state, and residence zip code. At their option, subscribers may also enter their first and last names, business name, street address, and phone number. Paid subscribers also enter their license plate, the state that issued their license plate, and their credit card number for payment. Once registered as either a paid subscriber or a free subscriber in step 72, the user can report the details of the driving behavior or driving incident in step 74 by entering the information via the internet or via a telephone by using an automated telephone attendant. After entering the detailed information relating to the driving behavior or driving incident, the detailed information is stored in an electronic database in step 76 as a driving incident report. Next, in step 78, the electronic database is utilized to determine whether the driving incident report relates to a free or paid subscriber. If the driving incident report does not relate to a free or paid subscriber, the incident report remains stored in the electronic database and the process for reporting the driving behavior or driving incident ends in step 77.

Next, the type of subscriber, i.e. free or paid, is determined in step 79. If the driving incident report relates to a free subscriber who has registered a license plate and entered a valid e-mail address, a notice is sent to the free subscriber in step 80 informing the free subscriber that an unsafe driving report has been made on their registered license plate number. The process for reporting the driving behavior or incident report then ends in step 77.

If the driving incident report relates to a paid subscriber, the paid subscriber is automatically sent a notice of an unsafe driving report and afforded access to the details of the report in step 82. After reviewing the detailed report, the paid subscriber can determine whether or not he or she wants to dispute the report in step 82. If the paid subscriber does not dispute the report, the process for reporting the driving behavior or driving incident ends in step 77. If the driving incident report is disputed in step 83, the paid subscriber can enter the details regarding his or her dispute in step 84 and submit the dispute details in step 86 so that they are stored in the electronic database in association with the driving incident report.

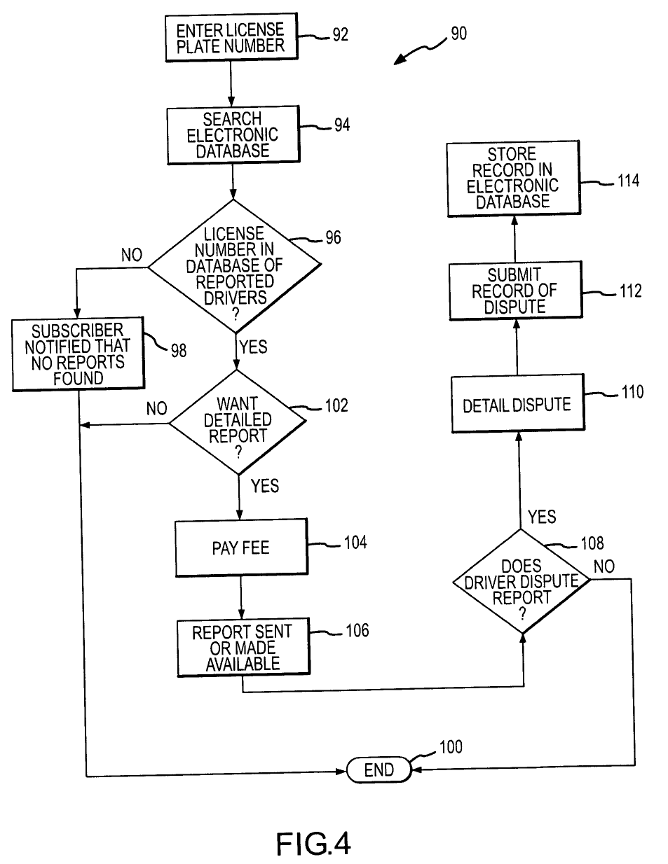

A flowchart depicting the detailed method for a free subscriber to obtain information on driving incident reports 90 in accordance with the present invention is shown in FIG. 4. In order to determine if the free subscriber has had any driving incident reports, the free subscriber first enters his or her license plate number in step 92 onto the webpage of the website for the Driving Improvement Observational Internet Registry (DIOIR). The license plate number is then searched for in the electronic database for the DIOIR in step 94 and the electronic database is used to determine whether the license plate number entered by the free subscriber is in the database of reported drivers in step 96.

If it is determined that the free subscriber's license plate number is not in the database of reported drivers in step 96, then the free subscriber is notified that no driving incident reports were found in step 98 and the process for obtaining information on driving incident reports ends in step 100. Alternatively, if it is determined that the free subscriber's license plate number is in the database of reported drivers in step 96, then the free subscriber is queried in step 102 as to whether they want to receive a copy of the detailed driving incident report for a predetermined fee. If the free subscriber does not want to pay the fee for obtaining a copy of the detailed driving incident report, the process for obtaining information on driving incident reports ends in step 100. However, if the free subscriber does pay the fee to obtain a copy of the report in step 104, a detailed copy of the report is either sent to the free subscriber or made available to the free subscriber for viewing in step 106.

Once the free subscriber is able to access the contents of the driving incident report in step 106, the free subscriber is given an opportunity to dispute the driving incident report in step 108. If the free subscriber elects to dispute the driving incident report in step 108, the free subscriber can enter the details regarding his or her dispute in step 110 and submit a record of the details regarding the dispute in step 112. Once the details regarding the free subscriber's dispute are submitted, they are stored in the electronic database that stores data in association with the driving incident reports in step 114 so that the free subscriber's dispute regarding the driving incident is reported along with any reporting of the driving incident.

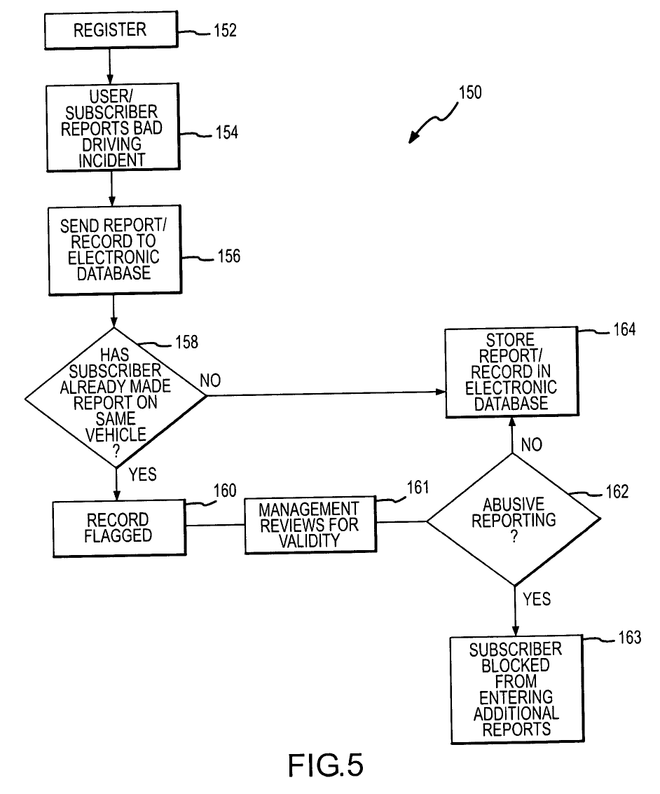

FIG. 5 is a flowchart showing the method for monitoring abuse in reporting incident reports 150 in accordance with the present invention. As previously described with reference to FIG. 3, which details the reporting of a driving behavior or incident, an individual or user who wants to report a driving behavior or driving incident that they observed must first register themselves with the service in step 152 by entering specific personal information. Once registered as either a paid subscriber or a free subscriber in step 152, the user can report the details of the driving behavior or driving incident in step 154 by entering the information via the internet or via a telephone by using an automated telephone attendant. After entering the detailed information relating to the driving behavior or driving incident, the detailed information is sent to an electronic database in step 156 as a driving incident report.

Next, in step 158, the electronic database is utilized to determine whether the subscriber has made a driving incident report on the same vehicle. If the subscriber has previously made a driving incident report on the same vehicle, the record is flagged for review in step 160. Next, management reviews the report for validity in step 161 and determines whether abusive reporting on a particular license plate number is occurring in step 162. If abusive reporting is occurring, the subscriber making the report is blocked from entering any additional incident reports on that vehicle in step 163. Alternatively, if it is determined in step 162 that abusive reporting is not occurring, then the report he is stored in the electronic database in step 164. In order to complete the process, the method then continues with the rest of the steps described with reference to FIG. 3 starting with step 78.

The described embodiments of this invention are to be considered in all respects only as illustrative and not as restrictive. Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention. The scope of the invention is therefore indicated by the appended claims rather than by the foregoing description. All changes, which come within the meaning and range of equivalency of the claims, are to be embraced within their scope.

What is claimed is:

1. A method for reporting and monitoring driving incidents comprising the steps of:
registering for a free subscription or a paid subscription on an internet based website;
reporting a driving incident using the license plate number and state of the vehicle involved in the driving incident;
storing the driving incident report in an electronic database;
determining whether the driving incident report is related to a free or paid subscriber; and
automatically notifying the free or paid subscriber of the driving incident report.

2. The method of claim 1 wherein the step of automatically notifying a paid subscriber of a driving incident report comprises the step of providing a detailed description of the driving incident.

3. The method of claim 2 further comprising the step of enabling the paid subscriber to dispute the driving incident report.

4. The method of claim 3 wherein the step of enabling the subscriber to dispute the driving incident report comprises the steps of:
describing and entering details of the subscriber's dispute; and
storing the details describing the dispute in the electronic database.

5. The method of claim 1 wherein the step of automatically notifying a free subscriber of a driving incident report comprises the step of enabling the free subscriber to obtain a detailed description of the driving incident by paying a predetermined fee.

6. The method of claim 5 further comprising the step of enabling the paid subscriber to dispute the driving incident report if they choose to obtain the detailed description of the driving incident.

7. The method of claim 6 wherein the step of enabling the subscriber to dispute the driving incident report comprises the steps of:
describing and entering details of the subscriber's dispute; and
storing the details describing the dispute in the electronic database.

8. The method of claim 1 wherein the step of reporting a driving incident comprises verbally reporting the incident to an automated telephonic system using a telephone or entering information relating to the incident onto a webpage using the internet.

9. The method of claim 1 wherein the step of reporting a driving incident comprises the step of authorizing at least one of a law enforcement agency or insurance company to contact a user a user reporting the driving incident.

10. The method of claim 1 wherein the step of reporting a driving incident using a license plate comprises inputting a driving observation and date of observation and at least one of a license plate year, a time of observation, a location of observation, a vehicle description, a driver description, and a narrative description.

11. The method of claim 1 wherein paid subscribers may register one or more license plate numbers to track driving behavior.

12. The method of claim 9 further comprising the step of providing customized reports to paid subscribers.

13. The method of claim 1 further comprising the step of swearing and affirming that the reported driving incident is true and accurate.

14. The method of claim 1 further comprising the step of electing whether to remain anonymous or available for contact after reporting a driving incident.

15. The method of claim 1 further comprising the step of tracking and storing at least one of a caller ID and e-mail address of an individual reporting a bad driving incident.

16. The method of claim 1 further comprising the step of providing information on the legal description of a violation relating to a driving incident report when automatically notifying the free or paid subscriber of the driving incident report.

17. The method of claim 1 further comprising the steps of:
determining whether a single user has reported a driving incident more than once against a specific vehicle;
flagging for review the single user reporting multiple driving incidents against a specific vehicle from further reporting;
reviewing the multiple driving incident reports made by the single user for validity; and
blocking the single user from entering additional driving incident reports against the vehicle.

18. The method of claim 1 further comprising the step of providing paid subscribers with at least one of a template and instructions for documenting and recording driving incidents prior to reporting them.

19. A system for reporting and obtaining information on driving incidents comprising:
an internet based registry housed in a website;
means for subscribing to the internet based registry as a paid subscriber or free subscriber;
means for reporting driving incidents using the internet based registry;
a server for accessing the internet based registry;
a database for storing driving incident reports entered into the internet based registry; and
means for automatically notifying free and paid subscribers that an incident report has been filed that relates to their license plate number.

20. The system of claim 19 wherein the means for automatically notifying paid subscribers of an incident report further comprises means for providing a detailed description of the incident.

21. The system of claim 19 further comprising means for free subscribers to obtain a detailed description of the driving incident upon paying a predetermined fee.
